(19) United States
(12) Patent Application Publication
(10) Pub. No.: US 2026/0249610 A1
(43) Pub. Date: Aug. 27, 2026

(54) LIQUID SUPPLY APPARATUS AND LIQUID EJECTION APPARATUS

(71) Applicant: SEIKO EPSON CORPORATION, Tokyo (JP)

(72) Inventor: Makoto SAWADAISHI, SHIOJIRI-SHI (JP)

(21) Appl. No.: 19/541,527

(22) Filed: Feb. 17, 2026

(30) Foreign Application Priority Data
Feb. 19, 2025 (JP) 2025-025267

(51) Int. Cl. B41J 2/14; B41J 2/165; B41J 2/175

(52) U.S. Cl. CPC B41J 2/1404; B41J 2/14; B41J 2/14233; B41J 2/1652; B41J 2/16526; B41J 2/17509

(57) ABSTRACT

A liquid supply apparatus includes: a supply flow path configured to supply the liquid from a liquid container configured to store the liquid to the liquid ejection head; a pressure-regulating valve configured to open the supply flow path when downstream pressure is smaller in magnitude than a predetermined pressure; a liquid feeding section disposed in the supply flow path located upstream of the pressure-regulating valve; and a branch flow path coupled to a first coupling portion disposed in the supply flow path located upstream of the liquid feeding section and a second coupling portion disposed in the supply flow path located between the liquid feeding section and the pressure-regulating valve, in which the branch flow path collects the liquid located between the liquid feeding section and the pressure-regulating valve and feeds the liquid collected to the liquid container in a state where the liquid feeding section is stopped.

The present application is based on, and claims priority from JP Application Serial Number 2025-025267, filed Feb. 19, 2025, the disclosure of which is hereby incorporated by reference herein in its entirety.

### BACKGROUND

### 1. Technical Field

The present disclosure relates to a liquid supply apparatus and a liquid ejection apparatus including the liquid supply apparatus.

### 2. Related Art

For example, as in JP-A-2009-160912, there is a liquid jet apparatus as an example of a liquid ejection apparatus including a liquid jet head as an example of a liquid ejection head and a liquid supply apparatus. The liquid supply apparatus supplies a liquid from a liquid supply source as an example of a liquid container to the liquid jet head. The liquid supply apparatus includes a pump as an example of a liquid feeding section, and an ejection-side valve. The pump pressure-feeds, to the liquid jet head, the liquid suctioned from the liquid supply source.

JP-A-2009-160912 is an example of the related art.

The ejection-side valve in JP-A-2009-160912 maintains the liquid in a pressurized state even after the pump stops driving. The liquid thus pressurized applies a load to a flow path. Therefore, for example, when the liquid is maintained in the pressurized state even during a standby period in which printing is not performed, there is a possibility that the liquid leaks.

### SUMMARY

A liquid supply apparatus which solves the problem described above is a liquid supply apparatus configured to be coupled to a liquid ejection head configured to eject a liquid from a nozzle, and including: a supply flow path configured to supply the liquid from a liquid container configured to store the liquid to the liquid ejection head; a pressure-regulating valve configured to open the supply flow path when downstream pressure is smaller in magnitude than a predetermined pressure; a liquid feeding section disposed in the supply flow path located upstream of the pressure-regulating valve and configured to feed the liquid in a supply direction; and a branch flow path coupled to a first coupling portion disposed in the supply flow path located upstream of the liquid feeding section and a second coupling portion disposed in the supply flow path located between the liquid feeding section and the pressure-regulating valve, in which the branch flow path collects the liquid located between the liquid feeding section and the pressure-regulating valve and feeds the liquid collected to the liquid container in a state where the liquid feeding section is stopped.

A liquid ejection apparatus which solves the problem described above includes: the liquid ejection head; and the liquid supply apparatus having the configuration described above.

### BRIEF DESCRIPTION OF THE DRAWINGS

FIG. 1 is a schematic diagram of an embodiment of a liquid ejection apparatus.

### DESCRIPTION OF EMBODIMENTS

### Embodiment

An embodiment of a liquid ejection apparatus will hereinafter be described with reference to the drawings. The liquid ejection apparatus is, for example, an inkjet type printer that discharges ink as an example of a liquid onto a medium such as paper, fabric, vinyl, a plastic component, or a metal component to perform printing.

### Liquid Ejection Apparatus

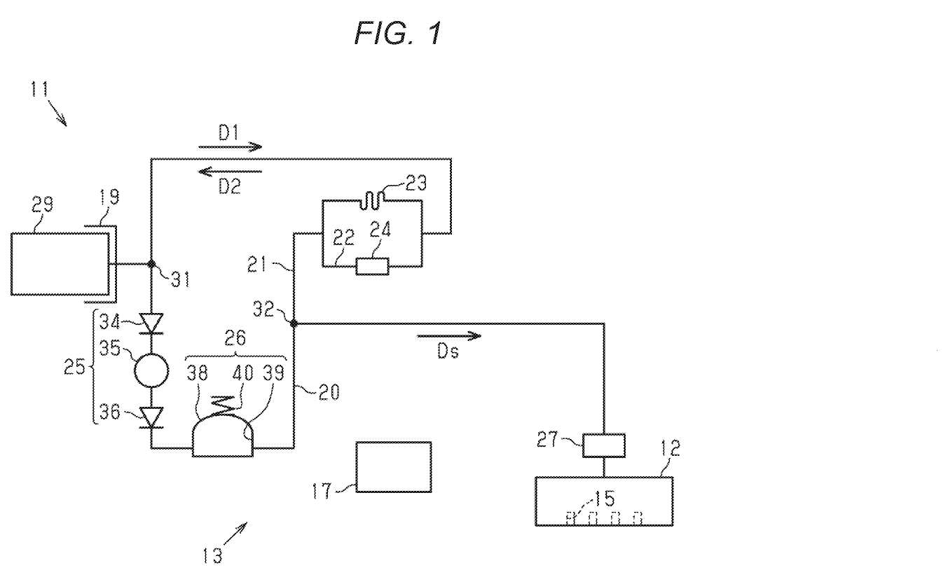

As illustrated in FIG. 1, a liquid ejection apparatus 11 may include a liquid ejection head 12 and a liquid supply apparatus 13.

The liquid ejection head 12 includes one or more nozzles 15. The liquid ejection head 12 can eject a liquid from the nozzles 15. The liquid ejection head 12 ejects the liquid from the nozzles 15 to perform printing on a medium (not shown).

### Liquid Supply Apparatus

The liquid supply apparatus 13 may include a controller 17. The controller 17 integrally controls driving of each mechanism in the liquid supply apparatus 13 and controls various operations executed in the liquid supply apparatus 13. The controller 17 may control various operations executed in the liquid ejection apparatus 11.

The controller 17 can be configured as a circuit including α: one or more processors that execute various kinds of processing in accordance with a computer program, β: one or more dedicated hardware circuits that execute at least some processing out of the various kinds of processing, or γ: a combination of α and β. The hardware circuit is, for example, an application specific integrated circuit. The processor includes a CPU and a memory such as a RAM and a ROM, and the memory stores program codes or commands configured to cause the CPU to execute the processing. The memory, that is, a computer-readable medium includes any readable medium that can be accessed by a general-purpose or dedicated computer.

The liquid supply apparatus 13 may include a mounting portion 19, a supply flow path 20, a branch flow path 21, and a parallel flow path 22. The liquid supply apparatus 13 may include a resistance flow path 23 and a regulator 24. The liquid supply apparatus 13 may include a liquid feeding section 25, a buffer 26, and a pressure-regulating valve 27.

The liquid supply apparatus 13 can be coupled to the liquid ejection head 12. The liquid supply apparatus 13 supplies the liquid to the liquid ejection head 12 from a liquid container 29 mounted on the mounting portion 19. The liquid flows through the supply flow path 20 in a supply direction Ds.

The liquid container 29 may be detachably attached to the mounting portion 19.

The liquid container 29 stores the liquid. The liquid container 29 can increase or decrease the liquid to be stored therein. The liquid container 29 can supply the liquid to the liquid supply apparatus 13 and collect the liquid returned from the liquid supply apparatus 13. The liquid container 29 may store the liquid in a bag having a variable volume. The liquid container 29 may store the liquid in a liquid chamber open to the atmosphere.

An upstream end of the supply flow path 20 in the supply direction Ds is coupled to the liquid container 29. The upstream end of the supply flow path 20 may be, for example, a hollow needle to be inserted into the liquid container 29. The upstream end of the supply flow path 20 may be provided to the mounting portion 19. By the supply flow path 20 being coupled to the liquid container 29 mounted on the mounting portion 19, the liquid stored in the liquid container 29 can be led out. A downstream end of the supply flow path 20 in the supply direction Ds is coupled to the liquid ejection head 12. The supply flow path 20 supplies the liquid from the liquid container 29 to the liquid ejection head 12.

The supply flow path 20 is provided with a first coupling portion 31 and a second coupling portion 32. The first coupling portion 31 is disposed upstream of the liquid feeding section 25. The first coupling portion 31 may be disposed between the upstream end of the supply flow path 20 and the liquid feeding section 25. The second coupling portion 32 is disposed downstream of the liquid feeding section 25. The second coupling portion 32 is disposed between the liquid feeding section 25 and the pressure-regulating valve 27. The second coupling portion 32 may be disposed between the buffer 26 and the pressure-regulating valve 27.

The branch flow path 21 branches from the supply flow path 20. The branch flow path 21 may be coupled to the first coupling portion 31 and the second coupling portion 32. That is, the branch flow path 21 may branch from the supply flow path 20 at the first coupling portion 31 and join the supply flow path 20 at the second coupling portion 32. The branch flow path 21 may branch from the supply flow path 20 at the second coupling portion 32 and join the supply flow path 20 at the first coupling portion 31.

The liquid can flow through the branch flow path 21 in a first branch direction D1 and a second branch direction D2 opposite to the first branch direction D1. The first branch direction D1 is a direction from the first coupling portion 31 toward the second coupling portion 32. The second branch direction D2 is a direction from the second coupling portion 32 toward the first coupling portion 31.

The resistance flow path 23 is provided to the branch flow path 21. The cross-sectional area of the resistance flow path 23 may be smaller than the cross-sectional area of the branch flow path 21. The resistance flow path 23 may be thinner than the branch flow path 21. The resistance flow path 23 may meander. The resistance flow path 23 increases resistance of the branch flow path 21. Specifically, the resistance of the branch flow path 21 is higher than the resistance of the supply flow path 20 between the liquid feeding section 25 and the pressure-regulating valve 27. The resistance of the branch flow path 21 is higher than the resistance of the supply flow path 20 between the second coupling portion 32 and the pressure-regulating valve 27. The resistance flow path 23 makes a flow rate of the liquid flowing through the branch flow path 21 lower than a flow rate of the liquid flowing through the supply flow path 20.

The parallel flow path 22 is disposed in parallel to the branch flow path 21. The parallel flow path 22 is coupled to both sides of the resistance flow path 23. Specifically, the parallel flow path 22 is coupled to the branch flow path 21 between the resistance flow path 23 and the first coupling portion 31 and the branch flow path 21 between the resistance flow path 23 and the second coupling portion 32.

The regulator 24 is disposed in the parallel flow path 22. The regulator 24 opens and closes the parallel flow path 22 in accordance with a difference in pressure between the parallel flow path 22 at the first coupling portion 31 side and the parallel flow path 22 at the second coupling portion 32 side. When the pressure difference is small, the regulator 24 closes the parallel flow path 22. When the pressure difference becomes larger than preset pressure, the regulator 24 opens the parallel flow path 22.

The liquid feeding section 25 is disposed in the supply flow path 20 upstream of the pressure-regulating valve 27. The liquid feeding section 25 may be disposed between the first coupling portion 31 and the buffer 26. The liquid feeding section 25 feeds the liquid in the supply direction Ds. The liquid feeding section 25 pressurizes the liquid to supply the liquid to the liquid ejection head 12. The liquid feeding section 25 may include a first one-way valve 34, a supply pump 35, and a second one-way valve 36.

The supply pump 35 is disposed between the first one-way valve 34 and the second one-way valve 36. The supply pump 35 is, for example, a diaphragm pump.

The first one-way valve 34 is disposed upstream of the supply pump 35. The second one-way valve 36 is disposed downstream of the supply pump 35. The first one-way valve 34 and the second one-way valve 36 allow the liquid to flow downstream in the supply direction Ds and restrict a flow of the liquid upstream.

The buffer 26 is disposed in the supply flow path 20 between the liquid feeding section 25 and the second coupling portion 32. The buffer 26 stabilizes the pressure of the liquid flowing through the supply flow path 20. The buffer 26 may include a flexible member 38, a storage chamber 39, and a supply spring 40.

The storage chamber 39 is disposed in the supply flow path 20. The storage chamber 39 stores the liquid. The flexible member 38 forms a part of a wall surface of the storage chamber 39. The flexible member 38 can flexurally be deformed. The flexible member 38 changes the volume of the storage chamber 39. The supply spring 40 pushes the flexible member 38 from the outside of the storage chamber 39. The supply spring 40 applies supply pressure to the liquid in the storage chamber 39.

The pressure-regulating valve 27 is disposed in the supply flow path 20 downstream of the liquid feeding section 25. The pressure-regulating valve 27 stabilizes the pressure of the liquid that is pressure-fed to the nozzles 15 by regulating the pressure of the liquid thus pressure-fed. The pressure-regulating valve 27 regulates the pressure of the liquid in the liquid ejection head 12 to pressure at which a meniscus is formed in the nozzle 15. The pressure-regulating valve 27 opens the supply flow path 20 when downstream pressure is lower than a predetermined pressure. For example, when the liquid is ejected from the nozzles 15 or the liquid is suctioned from the nozzles 15, the liquid in the liquid ejection head 12 decreases and the pressure of the liquid decreases. When the downstream negative pressure increases, the pressure-regulating valve 27 opens the supply flow path 20 to supply the liquid to the liquid ejection head 12.

### Functions of Present Embodiment

Functions of the present embodiment will be described.

When printing is performed on the medium, the controller 17 drives the liquid feeding section 25. The liquid feeding section 25 pressurizes the liquid located downstream of the liquid feeding section 25 by feeding the liquid in the supply direction Ds. When the liquid feeding section 25 is driven, the pressure in the first coupling portion 31 is lower than the pressure in the second coupling portion 32. The liquid in the supply flow path 20 flows into the branch flow path 21 from the second coupling portion 32. The liquid having flowed into the branch flow path 21 flows in the second branch direction D2 and flows out to the supply flow path 20 from the first coupling portion 31. However, the flow rate in the branch flow path 21 is suppressed by the resistance flow path 23. Therefore, the liquid is more likely supplied to the liquid ejection head 12 than to the branch flow path 21. The liquid is supplied to the liquid ejection head 12 in accordance with the ejection of the liquid.

When the liquid container 29 becomes empty during printing, the controller 17 stops driving the liquid feeding section 25. The controller 17 may notify a user to replace the liquid container 29. Even when the supply of the liquid by the liquid feeding section 25 is stopped, the buffer 26 supplies the liquid stored therein. That is, the supply spring 40 applies the supply pressure to the liquid in the storage chamber 39. Since the flow rate of the branch flow path 21 is suppressed, the liquid supplied from the buffer 26 is more likely supplied to the liquid ejection head 12 than to the branch flow path 21 similarly to when the liquid feeding section 25 is driven. By providing the buffer 26, it is possible to continue printing by an amount of the liquid stored therein even after the driving of the liquid feeding section 25 is stopped.

When the printing on the medium is completed, the controller 17 stops driving the liquid feeding section 25. The liquid feeding section 25 driving of which has stopped closes the supply flow path 20. Immediately after the driving of the liquid feeding section 25 is stopped, the pressure having been applied by the liquid feeding section 25 and the supply pressure by the supply spring 40 are applied to the liquid located between the liquid feeding section 25 and the pressure-regulating valve 27.

In a state where the liquid feeding section 25 is stopped, the branch flow path 21 collects the liquid between the liquid feeding section 25 and the pressure-regulating valve 27 and sends the liquid to the liquid container 29. That is, the pressure in the second coupling portion 32 is higher than the pressure of the liquid in the first coupling portion 31. The liquid in the supply flow path 20 flows into the branch flow path 21 from the second coupling portion 32. The liquid having flowed into the branch flow path 21 flows in the second branch direction D2 and flows out to the supply flow path 20 from the first coupling portion 31. The liquid having flowed out from the first coupling portion 31 to the supply flow path 20 flows through the supply flow path 20 in a direction opposite to the supply direction Ds and is collected in the liquid container 29.

The supply flow path 20 between the liquid feeding section 25 and the pressure-regulating valve 27 releases the liquid to the liquid container 29 via the branch flow path 21. The pressure in the supply flow path 20 between the liquid feeding section 25 and the pressure-regulating valve 27 gradually decreases. When the pressure in the first coupling portion 31 and the pressure in the second coupling portion 32 are balanced, the liquid in the branch flow path 21 stops flowing.

### Advantages of Present Embodiment

Advantages of the present embodiment will be described.

(1-1) In a state where the liquid feeding section 25 is stopped, the branch flow path 21 collects the liquid located downstream of the liquid feeding section 25 and feeds the liquid to the liquid container 29. Therefore, the pressure of the liquid pressurized by the liquid feeding section 25 can be reduced. Therefore, the possibility of liquid leakage can be reduced.

(1-2) The resistance of the branch flow path 21 is higher than the resistance of the supply flow path 20. That is, it is difficult for the liquid to flow through the branch flow path 21. Therefore, when the liquid feeding section 25 is driven, the liquid located between the liquid feeding section 25 and the pressure-regulating valve 27 becomes in the pressurized state, and is supplied to the liquid ejection head 12 when the pressure-regulating valve 27 is opened. When the liquid feeding section 25 is stopped, the liquid that has been pressurized is gradually collected in the liquid container 29 through the branch flow path 21. Therefore, it is possible to easily pressurize the liquid and to release the pressure.

(1-3) The resistance flow path 23 is disposed in the branch flow path 21. The resistance flow path 23 is smaller in cross-sectional area than the branch flow path 21. Therefore, it is possible to cause the liquid to flow through the branch flow path 21 at an appropriate flow rate with a simple configuration.

(1-4) The parallel flow path 22 provided with the regulator 24 is coupled to the branch flow path 21. Therefore, when the pressure in the supply flow path 20 becomes too high, the pressure can be released via the parallel flow path 22. By releasing the pressure, the possibility that an excessive load is applied to the pressure-regulating valve 27 can be reduced.

(1-5) The liquid container 29 is detachably attached to the mounting portion 19. Therefore, even when foreign matter such as a bubble is contained in the liquid returned to the liquid container 29, the liquid container 29 can easily be replaced.

### Modified Examples

The present embodiment can be implemented with the following modifications. The present embodiment and the following modified examples can be implemented in combination with each other as long as no technical inconsistencies are involved.

The liquid container 29 may be fixed to the mounting portion 19.

The liquid container 29 may be a liquid chamber disposed between the upstream end of the supply flow path 20 and the liquid feeding section 25.

The liquid supply apparatus 13 may have a configuration which does not include the resistance flow path 23, the parallel flow path 22, and the regulator 24. The liquid supply apparatus 13 may include a valve that opens and closes the branch flow path 21. The controller 17 may close the valve of the branch flow path 21 during printing, and may open the valve of the branch flow path 21 when printing is completed.

The liquid supply apparatus 13 may have a configuration which does not include the resistance flow path 23. For example, the resistance of the branch flow path 21 may be made higher than the resistance of the supply flow path 20 by making the cross-sectional area of the branch flow path 21 smaller than the cross-sectional area of the supply flow path 20.

The liquid ejection apparatus 11 can be a liquid ejection apparatus that jets or ejects other liquids than ink. The state of the liquid to be ejected from the liquid ejection apparatus as a minute amount of droplet includes a particle state, a teardrop state, and a state of tailing like a thread. The liquid mentioned here may sufficiently be any material that can be ejected from the liquid ejection apparatus. For example, the liquid may be any substance in a liquid phase and includes a liquid material high or low in viscosity, sol, gel water, other inorganic solvents, organic solvents, solutions, and a fluid material such as liquid resin, liquid metal, and metal melt. The liquid includes not only a liquid as one state of a substance, but also a liquid obtained by dissolving, dispersing, or mixing particles of a functional material formed of a solid substance such as pigments or metal particles in a solvent. Representative examples of the liquid include such ink as described in the above embodiment and a liquid crystal. Here, the term ink includes various types of liquid compositions such as general water-based ink, oil-based ink, gel ink, and hot melt ink. Specific examples of the liquid ejection apparatus include an apparatus that ejects a liquid containing, in a dispersed or dissolved form, a material such as an electrode material or a coloring material used for manufacturing, for example, a liquid crystal display, an electroluminescence display, a surface-emitting display, and a color filter. The liquid ejection apparatus may be an apparatus that ejects a bioorganic substance used for manufacturing a biochip, an apparatus that is used as a precision pipette and ejects a liquid to be a sample, a textile printing apparatus, a micro dispenser, or the like. The liquid ejection apparatus may be an apparatus that ejects lubricating oil to a precision machine such as a timepiece or a camera in a pinpoint manner, or an apparatus that ejects a liquid of transparent resin such as ultraviolet curable resin onto a substrate in order to form a minute hemispherical lens used for an optical communication element or the like, an optical lens, or the like. The liquid ejection apparatus may be an apparatus that ejects an etching liquid such as acid or alkali in order to etch a substrate or the like.

### Definitions

The expression "at least one" used in the present specification means "one or more" of desired options. For example, the expression "at least one" used in the present specification means "either one of alternatives" or "both of two alternatives" when the number of the alternatives is two. As another example, the expression "at least one" used in the present specification means "only one alternative", "a combination of any two alternatives", or "a combination of any three or more alternatives" when the number of alternatives is three or more.

### Appendices

Technical ideas understood from the embodiment and modified examples described above and the functions and advantages thereof will hereinafter be described.

[1] A liquid supply apparatus is a liquid supply apparatus configured to be coupled to a liquid ejection head configured to eject a liquid from a nozzle, and including: a supply flow path configured to supply the liquid from a liquid container configured to store the liquid to the liquid ejection head; a pressure-regulating valve configured to open the supply flow path when downstream pressure is smaller in magnitude than a predetermined pressure; a liquid feeding section disposed in the supply flow path located upstream of the pressure-regulating valve and configured to feed the liquid in a supply direction; and a branch flow path coupled to a first coupling portion disposed in the supply flow path located upstream of the liquid feeding section and a second coupling portion disposed in the supply flow path located between the liquid feeding section and the pressure-regulating valve, in which the branch flow path collects the liquid located between the liquid feeding section and the pressure-regulating valve and feeds the liquid collected to the liquid container in a state where the liquid feeding section is stopped.

According to this configuration, in a state where the liquid feeding section is stopped, the branch flow path collects the liquid located downstream of the liquid feeding section and feeds the liquid to the liquid container. Therefore, the pressure of the liquid pressurized by the liquid feeding section can be reduced. Therefore, the possibility of liquid leakage can be reduced.

[2] In the liquid supply apparatus according to [1] described above, resistance of the branch flow path may be higher than resistance of the supply flow path located between the second coupling portion and the pressure-regulating valve.

According to this configuration, the resistance of the branch flow path is higher than the resistance of the supply flow path. That is, it is difficult for the liquid to flow through the branch flow path. Therefore, when the liquid feeding section is driven, the liquid located between the liquid feeding section and the pressure-regulating valve becomes in the pressurized state, and is supplied to the liquid ejection head when the pressure-regulating valve is opened. When the liquid feeding section is stopped, the liquid that has been pressurized is gradually collected in the liquid container through the branch flow path. Therefore, it is possible to easily pressurize the liquid and to release the pressure.

[3] The liquid supply apparatus according to [2] described above may include a resistance flow path provided in the branch flow path, and the resistance flow path may be smaller in cross-sectional area than the branch flow path.

According to this configuration, the resistance flow path is disposed in the branch flow path. The resistance flow path has a cross-sectional area smaller than the branch flow path. Therefore, it is possible to cause the liquid to flow through the branch flow path at an appropriate flow rate with a simple configuration.

[4] The liquid supply apparatus according to [3] described above may include: a parallel flow path coupled to the branch flow path located between the resistance flow path and the first coupling portion and the branch flow path located between the resistance flow path and the second coupling portion; and a regulator disposed in the parallel flow path.

According to this configuration, the parallel flow path provided with the regulator is coupled to the branch flow path. Therefore, when the pressure in the supply flow path becomes too high, the pressure can be released via the parallel flow path.

[5] The liquid supply apparatus according to any one of [1] to [4] described above may include a mounting portion to which the liquid container is detachably attached.

According to this configuration, the liquid container is detachably attached to the mounting portion. Therefore, even when foreign matter such as a bubble is contained in the liquid returned to the liquid container, the liquid container can easily be replaced.

[6] A liquid ejection apparatus includes: the liquid ejection head; and the liquid supply apparatus according to any one of [1] to [5] described above.

According to this configuration, it is possible to achieve substantially the same advantages as those of the liquid supply apparatus described above.

What is claimed is:

1. A liquid supply apparatus configured to be coupled to a liquid ejection head configured to eject a liquid from a nozzle, the apparatus comprising:
a supply flow path configured to supply the liquid from a liquid container configured to store the liquid to the liquid ejection head;
a pressure-regulating valve configured to open the supply flow path when downstream pressure is smaller in magnitude than a predetermined pressure;
a liquid feeding section disposed in the supply flow path located upstream of the pressure-regulating valve and configured to feed the liquid in a supply direction; and
a branch flow path coupled to a first coupling portion disposed in the supply flow path located upstream of the liquid feeding section and a second coupling portion disposed in the supply flow path located between the liquid feeding section and the pressure-regulating valve, wherein
the branch flow path collects the liquid located between the liquid feeding section and the pressure-regulating valve and feeds the liquid collected to the liquid container in a state where the liquid feeding section is stopped.

2. The liquid supply apparatus according to claim 1, wherein
resistance of the branch flow path is higher than resistance of the supply flow path located between the second coupling portion and the pressure-regulating valve.

3. The liquid supply apparatus according to claim 2, further comprising
a resistance flow path disposed in the branch flow path, wherein
the resistance flow path is smaller in cross-sectional area than the branch flow path.

4. The liquid supply apparatus according to claim 3, further comprising:
a parallel flow path coupled to the branch flow path located between the resistance flow path and the first coupling portion and the branch flow path located between the resistance flow path and the second coupling portion; and
a regulator disposed in the parallel flow path.

5. The liquid supply apparatus according to claim 1, further comprising
a mounting portion to which the liquid container is detachably attached.

6. A liquid ejection apparatus comprising:
the liquid ejection head; and
the liquid supply apparatus according to claim 1.
